(19) United States
(12) Patent Application Publication
(10) Pub. No.: US 2015/0260212 A1
(43) Pub. Date: Sep. 17, 2015

(54) ASSEMBLY SYSTEM AND METHOD

(71) Applicant: Gifford W. Cochran, Bozeman, MT (US)

(72) Inventor: Gifford W. Cochran, Bozeman, MT (US)

(21) Appl. No.: 14/714,147

(22) Filed: May 15, 2015

Related U.S. Application Data
(63) Continuation-in-part of application No. 29/466,535, filed on Sep. 9, 2013, now Pat. No. D731215.

(30) Foreign Application Priority Data
Dec. 19, 2014 (MX) MX/E/2014/092558

(51) Int. Cl. F16B 12/00

(52) U.S. Cl. CPC F16B 12/00

(57) ABSTRACT

A method of attaching a first assembly element with a second assembly element comprising the steps of: inserting an end of the second assembly element having a groove into a recess associated with the first assembly element; causing the second assembly element to slide toward an edge of the recess having an undercut until the undercut engages the groove; and driving a wedge against a ramp of the recess and a face of the second assembly element which is opposite to the face having the groove.

### CROSS-REFERENCE TO RELATED APPLICATIONS

This application claims the benefit of U.S. Design Application No. 29466535, filed Sep. 9, 2013 and Mexican Application No. MX/E/2014/092558, filed Dec. 19, 2014, which are hereby incorporated by reference, to the extent that they are not conflicting with the present application.

### BACKGROUND OF THE INVENTION

1. Field of the Invention

The invention relates generally to assembly systems and methods and more particularly to a non-penetrating assembly system and method using grooves and wedges.

2. Description of the Related Art

With today's living spaces becoming smaller and storage space at a premium, the need for efficient use of those spaces has become more important. Additionally, with the costs of fuel and transportation increasing, it is ever more important to realize efficiencies in the shipping of goods. The less air shipped in a package the better.

Thus, there is a need for furniture (or other similar goods) of all kinds that use an innovative assembly system that allows the furniture to be easily assembled and disassembled multiple times so you can transport it or store it flat; to introduce or remove it in complicated and reduced current spaces; to lower the costs of transportation and storage; to make all of this easy without discrediting its aesthetic appearance and good functionality.

### BRIEF SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one exemplary embodiment, an assembly system and method is provided that allows one to join for example two flat pieces at 90 degrees (perpendicular), without cutting all the way through the receiving piece, by simply using grooves and wedges. The unique feature of the system is the way in which the pieces are joined. No full penetration of a piece with the other, no glued parts or screws or nails, rivets or any metal clips.

Using the system and method disclosed herein, a strong and rigid assembly is accomplished by the use of grooves that are locked together and are secured by a wedge inserted into a recess with a ramp with an inclination of, for example, 5 degrees. This rigid assembly is achieved only with the use of grooves and wedges and in most cases requires only one wedge, so that you can easily assemble and disassemble pieces multiple times without damage or wear to the furniture.

The system and method disclosed may be used for furniture assembly to obtain economical, flat transport and storage, and easy installation that requires no hardware. It can be used for all kinds of furniture such as chairs, tables, benches, shelves, and so on. For example, it can be used to attach a table top with the table legs or any number of pieces of furniture where it is required to have a firm assembly without one of the surfaces being perforated completely by another.

The above embodiments and advantages, as well as other embodiments and advantages, will become apparent from the ensuing description and accompanying drawings.

### BRIEF DESCRIPTION OF THE DRAWINGS

For exemplification purposes, and not for limitation purposes, embodiments of the invention are illustrated in the figures of the accompanying drawings, in which:

FIG. 1 is an isometric view of a recess of a first assembly element, according to an embodiment.

FIG. 2 is a top view of the recess from FIG. 1.

FIG. 3 is a cross section view of the recess from FIG. 2 along cutting plane A: A.

FIG. 4 is an isometric view of a second assembly element, according to an embodiment.

FIG. 5 is a top view of the front face of the second assembly element from FIG. 4.

FIG. 6 is a cross section view of the second assembly element from FIG. 5 along cutting plane B: B.

FIGS. 7-9 illustrate the process of joining the first and the second assembly elements, according to an embodiment.

FIG. 10 is a top view of the assembly resulting from joining the first and the second assembly elements as depicted in FIGS. 7-9.

### DETAILED DESCRIPTION OF THE PREFERRED EMBODIMENTS

What follows is a detailed description of the preferred embodiments of the invention in which the invention may be practiced. Reference will be made to the attached drawings, and the information included in the drawings is part of this detailed description. The specific preferred embodiments of the invention, which will be described herein, are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

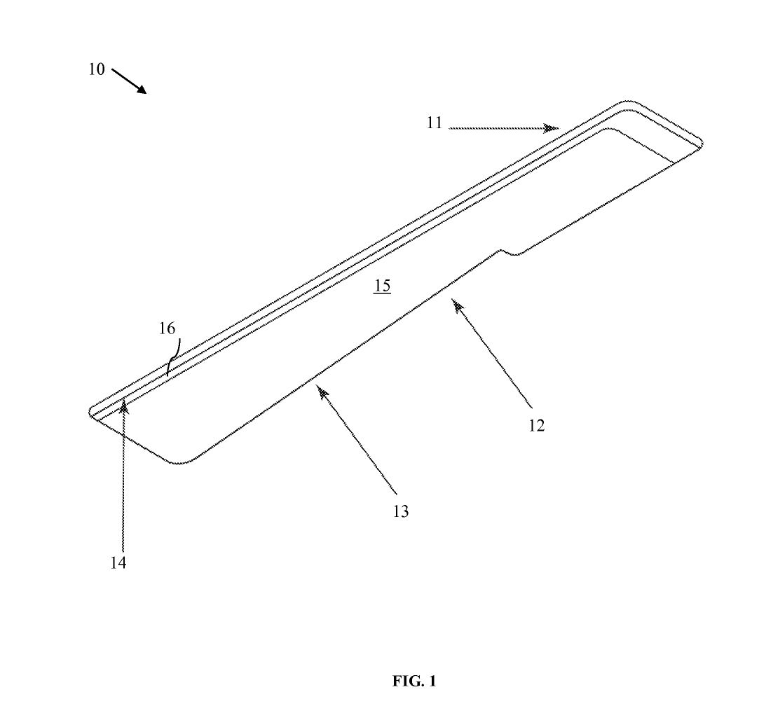

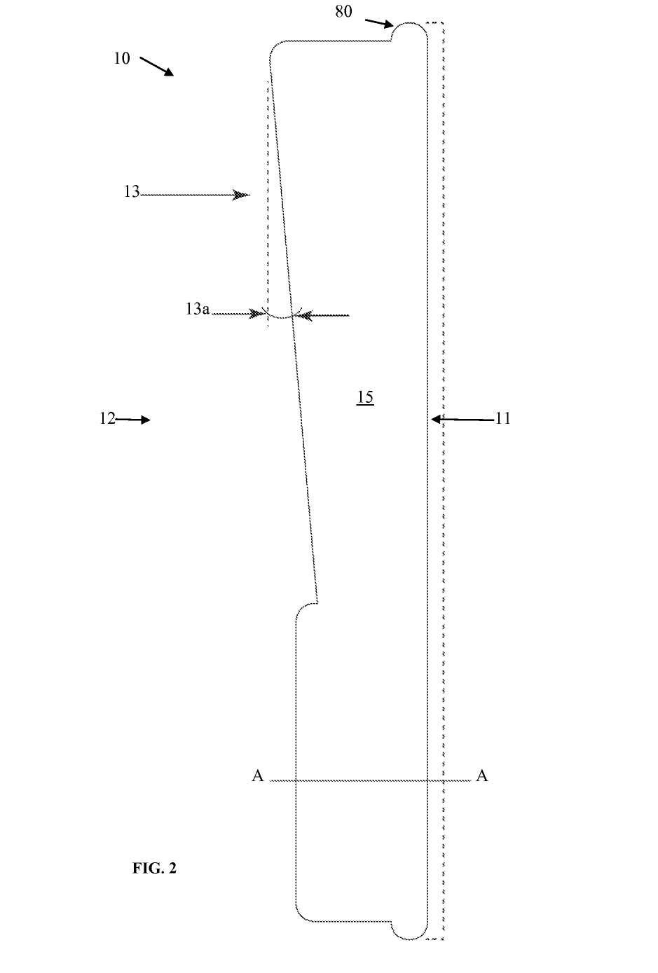

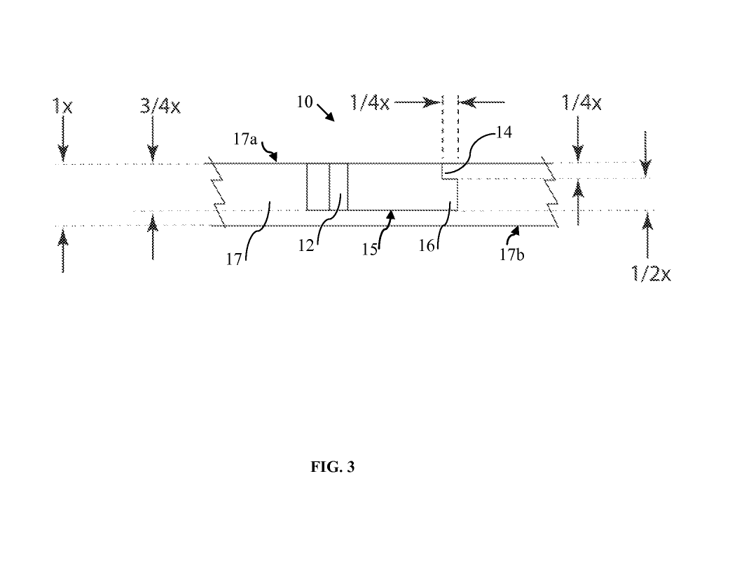

Reference will now be made to FIGS. 1-3. FIG. 1 is an isometric view of a recess of a first assembly element, according to an embodiment. FIG. 2 is a top view of the recess from FIG. 1. FIG. 3 is a cross section view of the recess from FIG. 2 along cutting plane A: A.

As can be seen in FIGS. 1-3, the recess 10 has a floor 15, which is preferably flat, a straight edge of greater length 11 and, opposite to it, an edge 12 with a ramp 13 having a certain inclination 13a (preferably 5 degrees). Preferably over its entire length, as shown, the longest straight edge 11 is preferably configured to have a fluting/undercut 16. It should be noted that the undercut/fluting 16 creates a lip 14 extending inwards, as better seen in FIG. 3.

It should be noted in FIG. 3 that some examples of dimensional relationships between elements of the recess 10 and a dimension (e.g., thickness) of the first assembly element 17 are provided. Again, these are examples only, thus other sizes for the recess 10 and its elements (e.g., lip 14 or fluting/undercut 16) may be adopted depending on such factors as the strength or thickness of the materials from which the first assembly element 17 is made (e.g., wood, aluminum, plastic, glass, etc.).

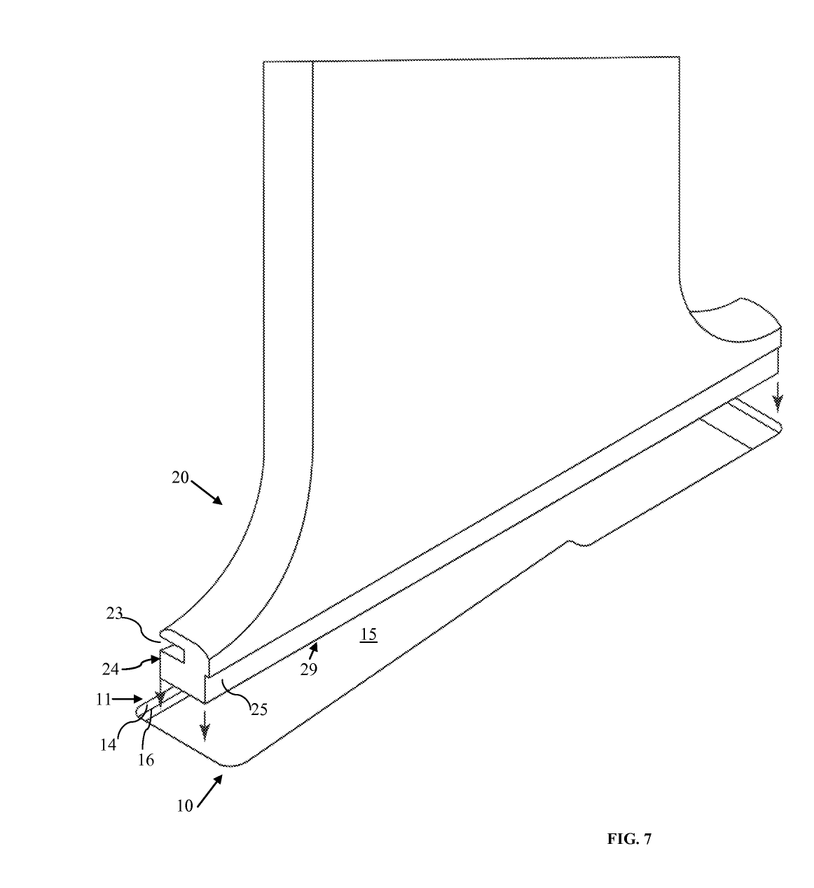

It should be observed that the recess 10 is formed into the first assembly element 17 such that it does not penetrate completely the first assembly element 17. Because of that, the recess 10 has a floor 15, and, while the recess 10 can be seen from one side 17a of the first assembly element 17, it cannot be seen from the opposite side 17b, if the first assembly element 17 is made from an opaque material. This has significant advantages, such as to mask the joint created using recess 10, when, for example the joint is used in a furniture piece. Another advantage is that floor 15 may contribute to the strength of the resulting joint, as it will be apparent from the below description referring to FIGS. 7-9.

One of ordinary skill in the art would understand that various suitable processes may be adopted to form the recess 10 into the first assembly element 17. The list of such processes may include cutting, carving, casting, and so on. Also, it should be noted that an overcut 80 (FIG. 2) may be used to facilitate the insertion of the second assembly element 20 into the recess 10.

One of ordinary skill in the art would further understand that the recess 10 could for example also be a structure associated with and/or extending from one of the faces (e.g., 17a) of the first assembly element 17, thus not being embodied into the first assembly element 17 as preferred and depicted in FIG. 3, while still fulfilling a similar function. Such variation and other similar variations would not depart from the scope of this disclosure.

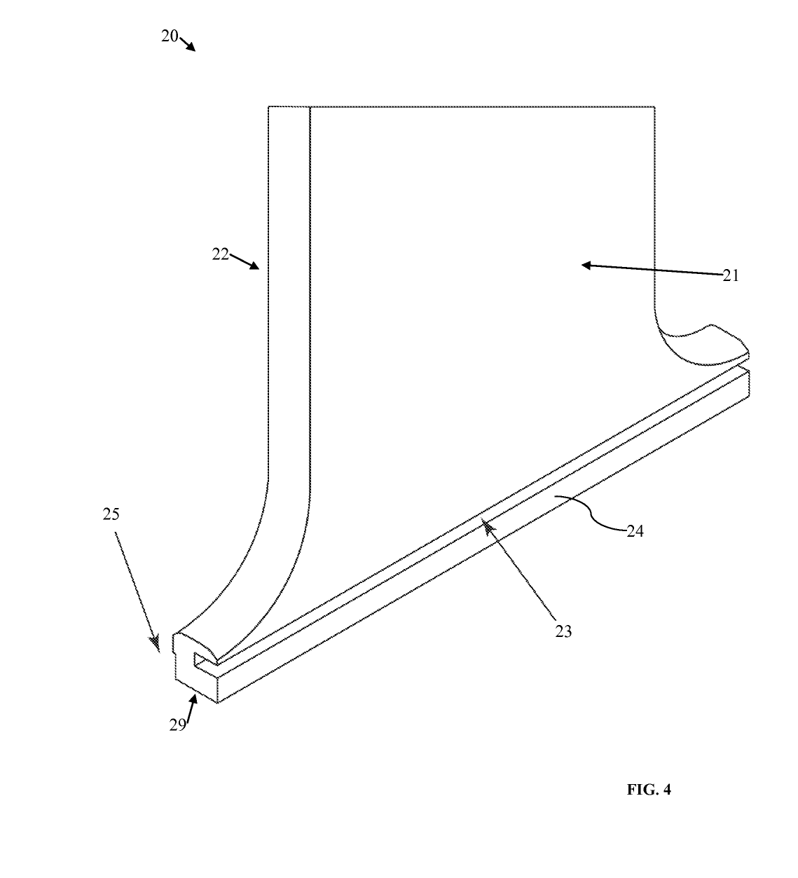

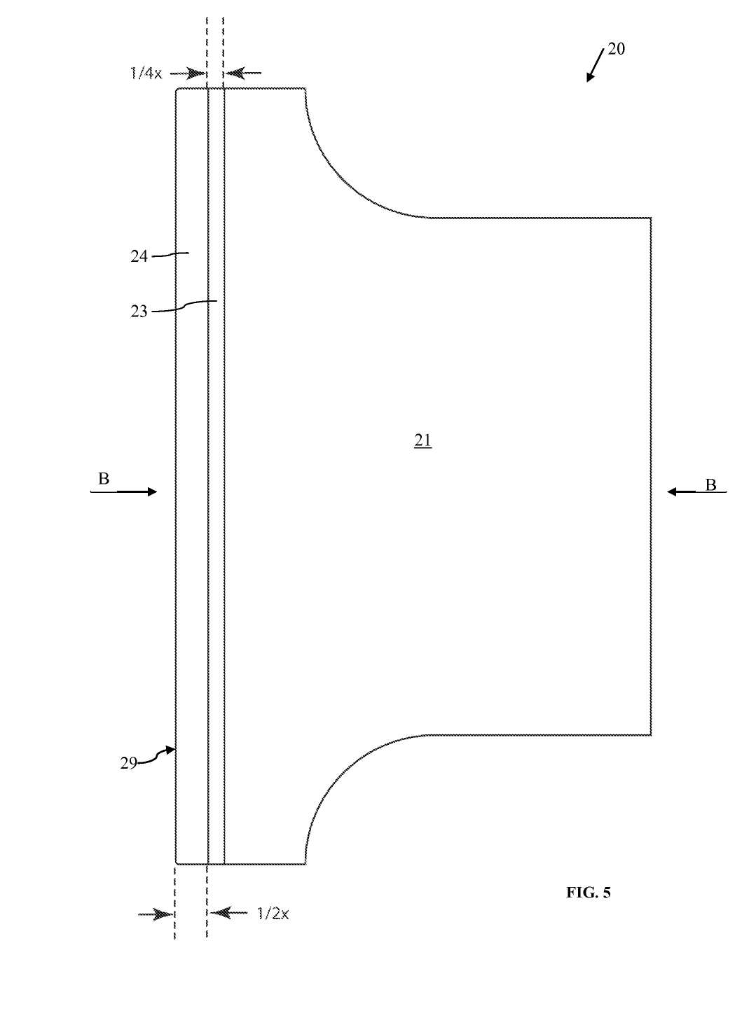

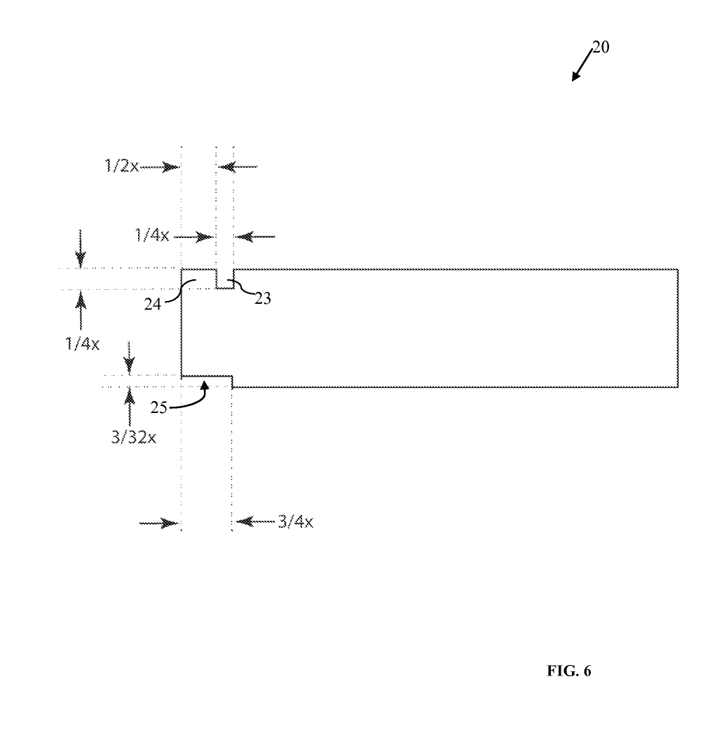

Reference will now be made to FIGS. 4-6. FIG. 4 is an isometric view of a second assembly element, according to an embodiment. FIG. 5 is a top view of the front face of the second assembly element from FIG. 4. FIG. 6 is a cross section view of the second assembly element from FIG. 5 along cutting plane B: B.

The second assembly element 20 is the other piece that will form the assembly by joining with the first assembly element 10, as it will be described in detail hereinafter when referring to FIGS. 7-10. As shown, the second assembly element 20 may have a front face 21 and a back face 22, and a longitudinal slot/groove 23 on its front face 21 and near the bottom 29 of the second assembly element 20. As shown, the presence of the longitudinal slot/groove 23 creates a flange 24 between the bottom 29 and the longitudinal slot 23 of the second assembly element 20.

The longitudinal slot/groove 23 of the second assembly element 20 is preferably shaped and sized to fit snugly over the lip 14 of the first assembly element 10. The flange 24 is preferably shaped and sized to fit snugly into the fluting 16 of the first assembly element 10.

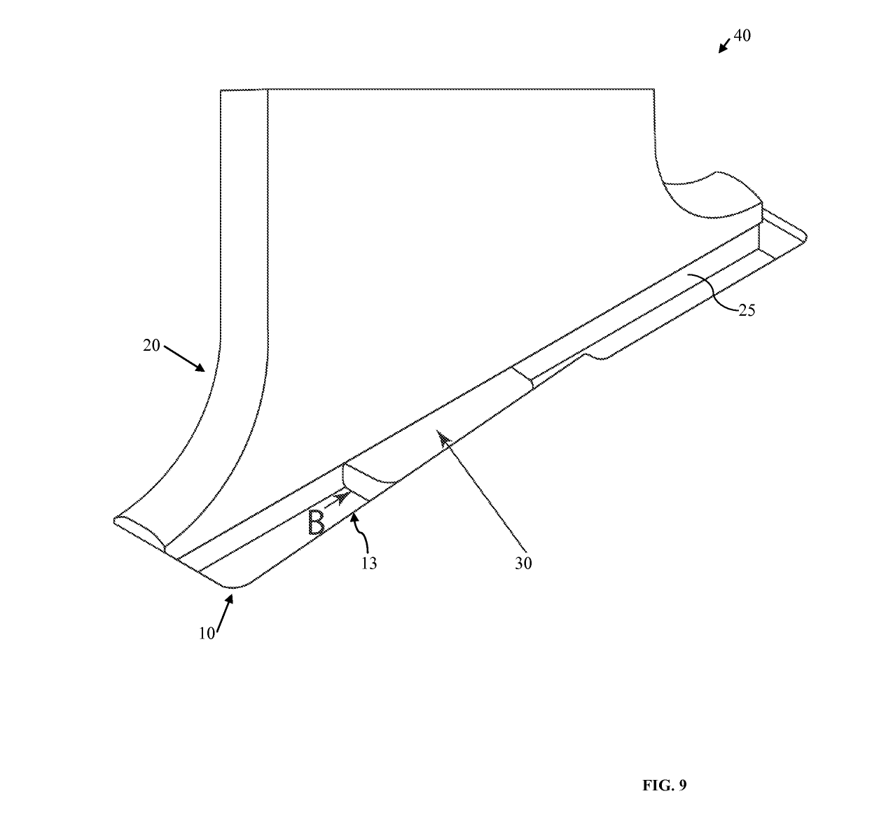

As shown, the back face 22 has a shoulder 25, which is preferably shaped and sized to receive snugly a portion of the wedge 30 (see FIG. 9), in order to lock the assembly, as it will be described hereinafter when referring to FIGS. 7-10. Element 25, prevents the wedge from falling out, should it loosen.

It should be noted that in FIGS. 5-6 some examples of dimensional relationships between elements of the second assembly element 20 are provided. Again, these are examples only, thus other sizes may be adopted depending on such factors as the strength of the material and the thickness from which the second assembly element 20 is made (e.g., wood, aluminum, plastic, glass, etc.).

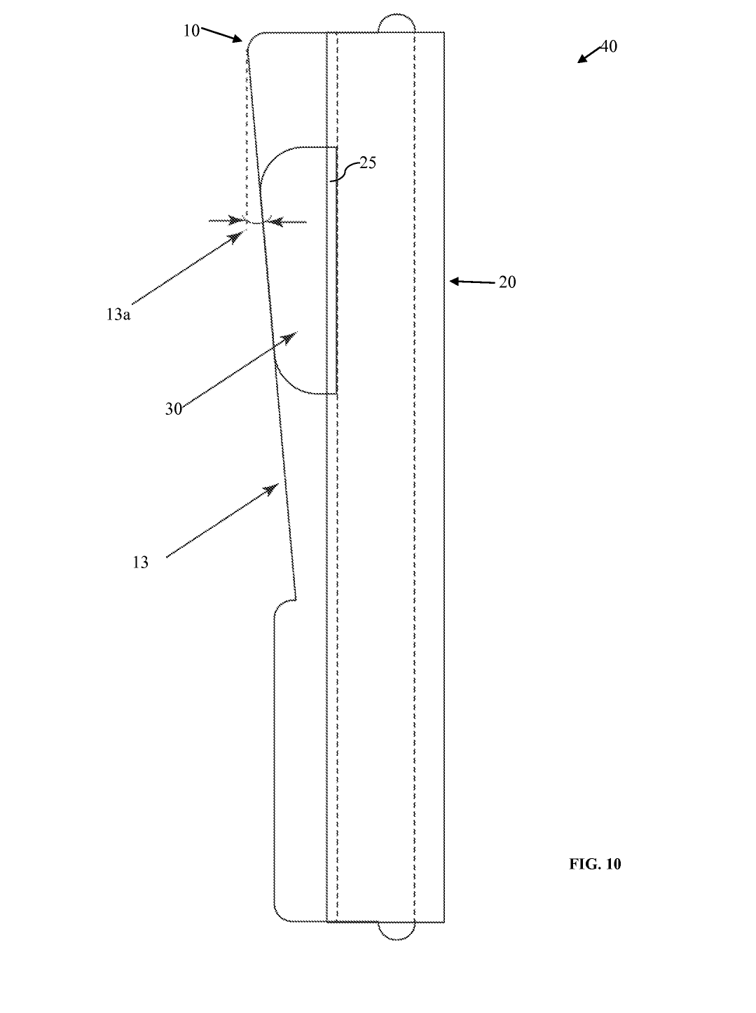

Reference will now be made to FIGS. 7-10. FIGS. 7-9 illustrate the process of joining the first and the second assembly elements, according to an embodiment. FIG. 10 is a top view of the assembly resulting from joining the first and the second assembly elements as depicted in FIGS. 7-9.

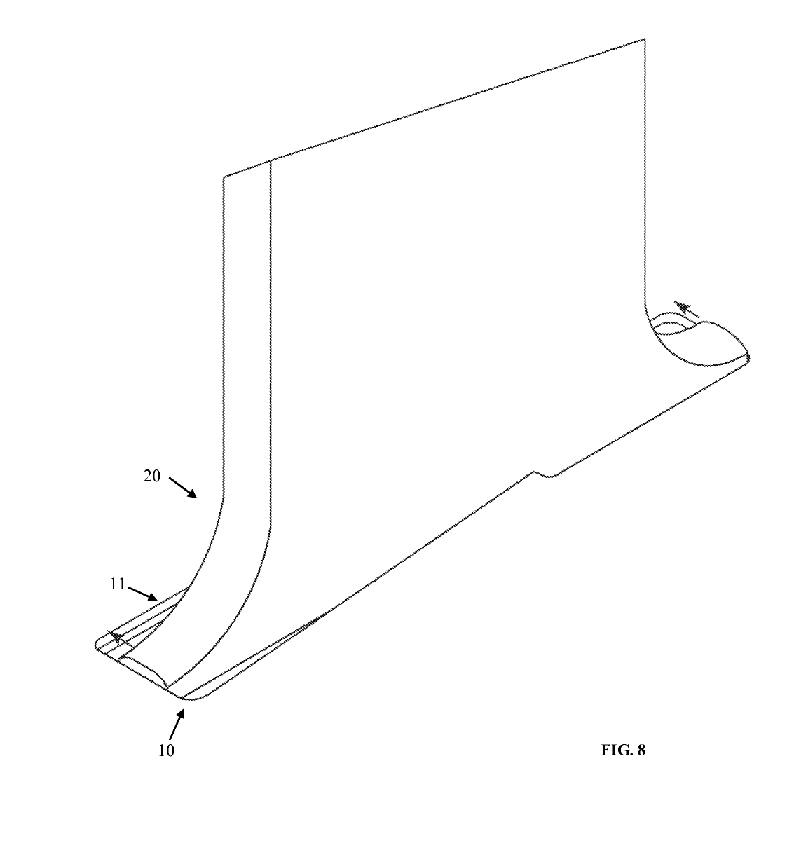

FIG. 7 is an isometric view where the first step of the assembly process is shown. As shown, first, the second assembly element 20 is inserted into the recess 10 of the first assembly element 17 (FIG. 3), such that preferably the bottom 29 of the second assembly element 20 touches the floor 15 of recess 10. Next, as shown in FIG. 8, the second assembly element is pushed to slide toward the straight edge of greater length 11 of recess 10 and until the lip 14 of the first assembly element 10 enters the longitudinal slot 23 (see FIG. 7) of the second assembly element 20, and the flange 24 of the second assembly element 20 enter the fluting/undercut 16 of the first assembly element 10. Next, as shown in FIG. 9, for securing the assembly 40 of both pieces, a wedge 30 is inserted into the recess 10 between the recess 25 of the second assembly element 20 and the ramp 13 of recess 10 and pushed to slide (from left to right (B) in FIG. 9) to press hard enough onto the second assembly element 20, to keep it in place and thus make the assembly 40 secure. As it can be seen in the top view in FIG. 10, angle 13a (e.g., 5 degrees) of ramp 13 corresponds and cooperates with the slope of the wedge 30 to create enough pressure to be introduced to second assembly element 20. It should be also noted that recess 25 contributes to preventing the wedge 30 from escaping the construct. It should be noted as well that more than one wedge 30 may be used if the parts are configured appropriately.

Thus, it should be apparent that the system and method disclosed herein allows one to join for example two flat pieces of different or similar thicknesses at 90 degrees (perpendicular), without puncture or penetration, by simply using one or more wedges. The unique feature of the system is the way in which the pieces are joined. No full penetration of a piece with the other, no glued parts or screws or nails, rivets or any metal clips.

Using the system and method disclosed herein, a strong and rigid assembly may be accomplished by the use of grooves that are locked together and are secured by a wedge inserted in a recess with a ramp with an inclination of, for example, 5 degrees.

Again, the system and method disclosed herein may be used to assemble furniture. For example, the first assembly element 17 having the recess 10 may be the flat top of a table and the second assembly element 20 may be a leg or a leg set of the table. However, it should be understood that the system and method disclosed herein may also be used to assemble other items such as art pieces, toys, and so on.

It should be noted that a ninety degrees (perpendicular) joint was disclosed herein. However, it should be understood that a deviation from the perpendicular configuration (e.g., 95 degrees) may be adopted if needed, by correspondingly adjusting the surfaces of the interlocking elements described.

It may be advantageous to set forth definitions of certain words and phrases used in this patent document. The phrases “associated with” and “associated therewith,” as well as derivatives thereof, may mean to include, be included within, interconnect with, contain, be contained within, connect to or with, couple to or with, be communicable with, cooperate with, interweave, juxtapose, be proximate to, be bound to or with, have, have a property of, or the like.

As used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims. Use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having the same name (but for use of the ordinal term) to distinguish the claim elements. As used in this application, “and/or” means that the listed items are alternatives, but the alternatives also include any combination of the listed items.

Throughout this description, the embodiments and examples shown should be considered as exemplars, rather than limitations on the apparatus and procedures disclosed or claimed. Although many of the examples involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the described methods. Acts, elements and features discussed only in connection with one embodiment are not intended to be excluded from a similar role in other embodiments.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the invention. Therefore, the scope of this application is intended to cover alternate embodiments and/or equivalent variations of the specific embodiments illustrated and/or described herein. Hence, the scope of the invention is defined by the accompanying claims and their equivalents. Furthermore, each and every claim is incorporated as further disclosure into the specification and the claims are embodiment(s) of the invention.

What is claimed is:

1. A method of attaching a first assembly element having a recess associated with a first side without penetrating an opposite side of the first assembly element, the recess having an undercut on a first edge of the recess, such that a lip facing inward is created between the undercut and the first side, and a ramp on an opposite edge of the recess, with a second assembly element having a groove formed in a first face and near a first end of the second assembly element, such that a flange is created between the first end and the groove, comprising the steps of:
inserting the first end of the second assembly element into the recess associated with the first assembly element, with the groove facing the undercut;
causing the second assembly element to slide toward the first edge of the recess until the flange engages the undercut and the lip engages the groove; and
driving a wedge against the ramp and a face of the second assembly element which is opposite to the first face.

2. The method of claim 1, wherein the first side of the first assembly element is planar and the recess is formed into the first assembly element's thickness between the first side and the opposite side, without penetrating the opposite side.

3. The method of claim 2, wherein the recess is formed by cutting.

4. The method of claim 1, wherein the groove is formed by cutting.

5. The method of claim 1, wherein the first and second assembly elements are attached at ninety degrees.

6. The method of claim 1, further comprising providing a shoulder into the face of the second assembly element which is opposite to the first face to receive a portion of the wedge.

7. The method of claim 1, wherein the first assembly element is a top of a table and the second assembly element is a leg of the table.

8. A method of attaching a first assembly element with a second assembly element comprising the steps of: inserting an end of the second assembly element having a groove into a recess associated with the first assembly element; causing the second assembly element to slide toward an edge of the recess having an undercut until the undercut engages the groove; and driving a wedge against a ramp of the recess and a face of the second assembly element which is opposite to the face having the groove.
